(19) United States
(12) Patent Application Publication
(10) Pub. No.: US 2025/0037054 A1
(43) Pub. Date: Jan. 30, 2025

(54) OPERATION SUPPORT DEVICE, OPERATION SUPPORT METHOD, AND OPERATION SUPPORT PROGRAM

(71) Applicant: Nippon Telegraph and Telephone Corporation, Tokyo (JP)

(72) Inventors: Koki NAKANISHI, Musashino-shi, Tokyo (JP); Fumihiro YOKOSE, Musashino-shi, Tokyo (JP); Haruo OISHI, Musashino-shi, Tokyo (JP)

(21) Appl. No.: 18/717,625

(22) PCT Filed: Dec. 13, 2021
(86) PCT No.: PCT/JP2021/045911

§ 371 Date: Jun. 7, 2024

(51) Int. Cl. G06Q 10/0633

(52) U.S. Cl. CPC G06Q 10/0633

(57) ABSTRACT

An operation support apparatus acquires a value related to determination on a conditional branch in a PAD from configuration information of an apparatus to be operated, and detects a conditional branch node from the PAD using the acquired value. Then, the operation support apparatus determines whether the apparatus to be operated satisfies a condition indicated by the detected conditional branch node by using the acquired value. Thereafter, the operation support apparatus hides, from the PAD, a branch node when the apparatus to be operated does not satisfy the condition indicated by the conditional branch node.

### TECHNICAL FIELD

The present invention relates to an operation support apparatus, an operation support method, and an operation support program.

### BACKGROUND ART

Conventionally, a problem analysis diagram (PAD) is known as a method of describing an operation procedure (process) of an apparatus in an operation manual of the apparatus or the like as in a flowchart. For example, an operator of the apparatus performs the setting operation of the apparatus while viewing the procedure of the setting operation of the apparatus described by the PAD or the like.

Here, the operation procedure described by the PAD or the like may include a conditional branch. For example, an operation procedure including a conditional branch, such as if the OS name of an apparatus to be operated is “aa” and the version of the OS is “xx”, perform an operation A, otherwise perform an operation B, may be described.

### CITATION LIST

### Non Patent Literature

Non Patent Literature 1: Futamura Yoshihiko et al., Design and Implementation of Programs by Problem Analysis Diagram (PAD), Journal of Information Processing Society of Japan, Vol. 21 No. 4, pp 259-267, July 1980.
Non Patent Literature 2: Nakanishi Koki, Pad zu wo mochiita bunki ga hassei suru souchi settei tejyunsho no sakusei shuhou (in Japanese) (Method for Creating Device Setting Procedure Manual That Has Branch Using Pad), 2020 IEICE Society Conference, B14-6, 2020.

### SUMMARY OF INVENTION

### Technical Problem

In the above case, an operator needs to check a branch condition (for example, OS name, version, and the like) each time the conditional branch appears in an operation procedure, and determine whether an apparatus to be operated satisfies the branch condition. For this reason, there is a problem that it is difficult for the operator to have a prospect of how much operation work of the apparatus is as a whole. In addition, the above operation procedure may include a plurality of conditional branches having the same branch condition. In such a case, the operator needs to repeat the same determination each time the operator moves to a conditional branch having the same branch condition.

Therefore, the present invention solves the above described problem, and an object of the present invention is to reduce the number of determinations of the operator associated with the conditional branch when the operator operates an apparatus on the basis of information indicating the operation procedure of the apparatus, and to make it easy to make a prospect of the workload associated with the operation.

### Solution to Problem

To solve the above problem, the present invention includes a detection unit configured to detect, from operation flow information that represents an operation procedure for apparatuses by a tree structure in which an operation content is a node, a node of a conditional branch in the operation procedure and a display control unit configured to hide a branch node of branch nodes of the conditional branch node detected from the operation flow information, the branch node being for a case in which an apparatus to be operated does not satisfy a branch condition set for the conditional branch node.

### Advantageous Effects of Invention

According to the present invention, when the operator operates an apparatus on the basis of information indicating the operation procedure of the apparatus, it is possible to reduce the number of determinations of the operator associated with the conditional branch and to easily make a prospect of the workload associated with the operation.

### BRIEF DESCRIPTION OF DRAWINGS

FIG. 1 is a diagram for describing an operation outline of an operation support apparatus according to a first embodiment.

FIG. 2 is a diagram illustrating a configuration example of the operation support apparatus according to the first embodiment.

FIG. 3 is a flowchart illustrating an example of a processing procedure of the operation support apparatus according to the first embodiment.

FIG. 4 is a diagram illustrating an example of a screen for selecting a branch condition to be displayed.

FIG. 5 is a diagram for describing an operation outline of an operation support apparatus according to a second embodiment.

FIG. 6 is a diagram illustrating a configuration example of the operation support apparatus according to the second embodiment.

FIG. 7 is a diagram illustrating a configuration example of the operation support apparatus according to other embodiments.

FIG. 8 is a diagram illustrating an example of a screen displayed by the operation support apparatus of FIG. 7.

FIG. 9 is a diagram illustrating a configuration example of a computer that executes an operation support program.

### DESCRIPTION OF EMBODIMENTS

Hereinafter, modes (embodiments) for carrying out the present invention will be described separately into a first embodiment and a second embodiment with reference to the drawings. The present invention is not limited to the embodiments described below.

Note that, in the following description, a case where the operation procedure of apparatuses is described by a problem analysis diagram (PAD) will be described as an example, but the operation procedure is not limited to the PAD as long as the operation procedure is operation flow information in which the operation content is a node and a series of operation procedures are described by a tree structure.

### First Embodiment

An operation support apparatus according to the first embodiment uses the configuration information of an apparatus to display a PAD illustrating the operation procedure of the apparatus.

### [Outline of Operation Support Apparatus]

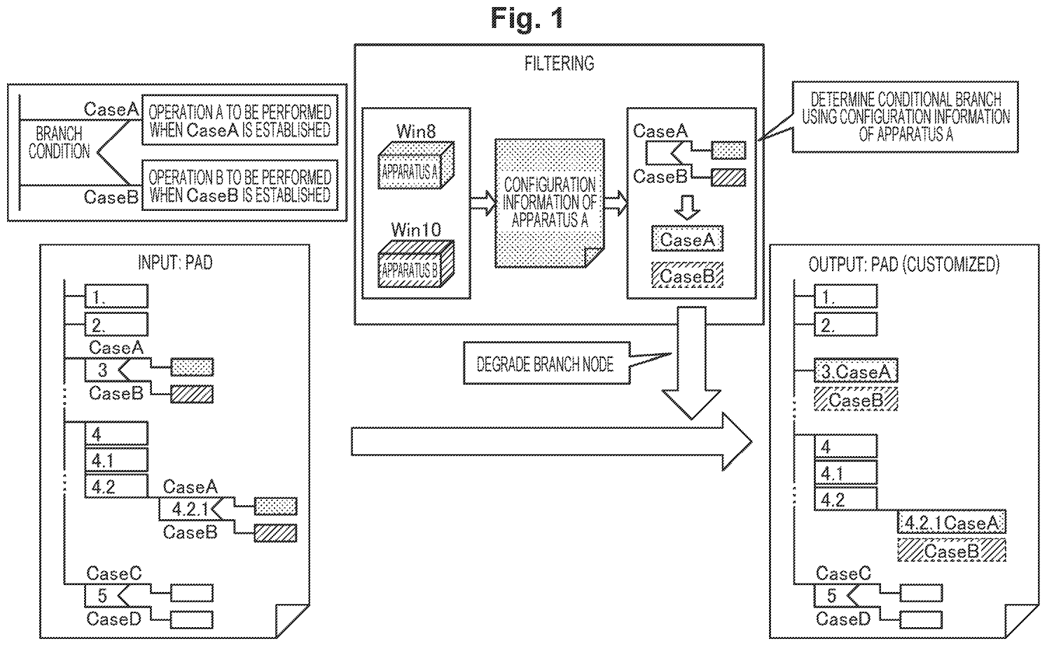

The outline of an operation support apparatus according to the first embodiment will be described with reference to FIG. 1. For example, when the operation support apparatus receives an input of a PAD illustrating operation procedures of apparatuses, the operation support apparatus displays a PAD illustrating (customized for) an operation procedure to be performed on an apparatus to be operated among the operation procedures illustrated in the PAD.

The PAD includes conditional branches. Branch conditions are described in the nodes (conditional branch nodes) indicating the conditional branches. A conditional branch node branches into, for example, a node indicating an operation performed in a case where the condition is satisfied (for example, in a case where Case A is established) and a node indicating an operation performed in other cases (for example, in a case where Case B is established).

Upon receiving an input of the PAD illustrating the operation procedure of apparatuses, the operation support apparatus extracts, from the configuration information of an apparatus A to be operated, a value (for example, OS name and version of the apparatus, and the like) related to conditional branches of the operation procedure. Then, the operation support apparatus finds, from the PAD, a conditional branch node that branches under the condition of the extracted value. That is, the operation support apparatus determines the conditional branch in the PAD using the configuration information of the apparatus A to be operated.

Here, for example, a case where the OS name and version of the apparatus A to be operated correspond to “Case A” will be considered. In this case, the operation support apparatus first finds a conditional branch node that conditionally branches with “Case A” and “Case B” among the conditional branch nodes in the PAD. Next, the operation support apparatus displays a node in the tree under Case A of the nodes branching from the conditional branch node, and hides the node in the tree under Case B. That is, the operation support apparatus performs filtering processing that degrades the branch node of Case B in the PAD.

As a result, the operation support apparatus can display a PAD illustrating the operation to be performed on the apparatus A to be operated. In addition, the operation support apparatus can reduce the number of conditional branches in the PAD by the filtering processing described above. As a result, the number of determinations of an operator associated with conditional branches of the operation procedure can be reduced. In addition, the operator can easily make a prospect of the workload of the operation of the apparatus.

### Configuration Example

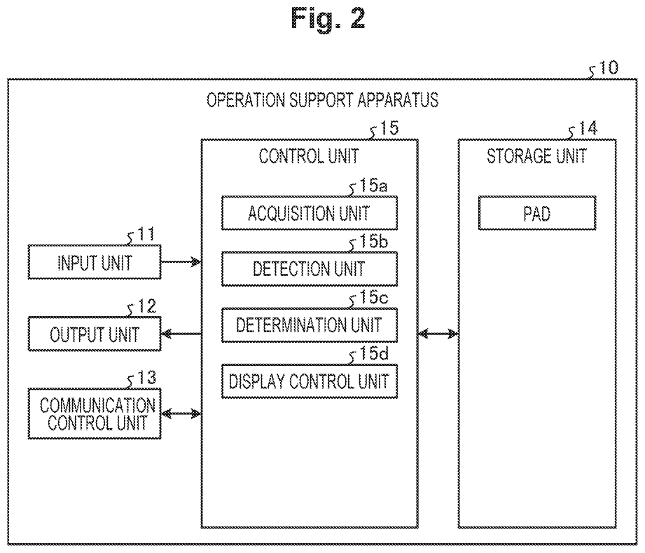

Next, a configuration example of an operation support apparatus 10 will be described with reference to FIG. 2. The operation support apparatus 10 is implemented by a general-purpose computer such as a personal computer, and includes an input unit 11, an output unit 12, a communication control unit 13, a storage unit 14, and a control unit 15.

The input unit 11 is an interface that receives an input operation from an input device such as a keyboard or a mouse. The output unit 12 is an interface for outputting data to a display device such as a liquid crystal display, a printing device such as a printer, and the like. For example, the output unit 12 displays the PAD or the like display-controlled by the control unit 15.

The communication control unit 13 is implemented by a network interface card (NIC) or the like and controls communication between an external device and the control unit 15 via a telecommunication line such as a local area network (LAN) or the Internet.

The storage unit 14 is implemented by a semiconductor memory element such as a random access memory (RAM) or a flash memory, or a storage device such as a hard disk or an optical disc. In the storage unit 14, a processing program for operating the operation support apparatus 10, data to be used during execution of the processing program, and the like are stored in advance or temporarily stored each time processing is performed. The storage unit 14 stores, for example, the PAD or the like illustrating the operation procedure of apparatuses.

The control unit 15 is implemented by a central processing unit (CPU) or the like and executes the processing program stored in the memory. Accordingly, the control unit 15 functions as an acquisition unit 15a, a detection unit 15b, a determination unit 15c, and a display control unit 15d as illustrated in FIG. 2. Note that each or some of these functional units may be implemented in different pieces of hardware.

The acquisition unit 15a acquires, from the configuration information of an apparatus to be operated, a value related to determination on a conditional branch. For example, the acquisition unit 15a acquires, from the apparatus to be operated, the configuration information of the apparatus. Then, the acquisition unit 15a acquires, from the acquired configuration information, a value (for example, OS name, OS version, and the like of the apparatus) related to determination on a conditional branch in the operation procedure of the apparatus.

The detection unit 15b detects a node of a conditional branch from the PAD illustrating the operation procedure for apparatuses. For example, the detection unit 15b uses the value (for example, the OS name, the version of the OS, and the like of the apparatus to be operated) acquired by the acquisition unit 15a to detect, from the PAD, a conditional branch node that branches with the above value as a condition.

The determination unit 15c determines, for each conditional branch node detected by the detection unit 15b, whether the apparatus to be operated satisfies a condition (branch condition) set for the conditional branch node, using the value (for example, the OS name, the OS version, and the like of the apparatus) acquired by the acquisition unit 15a.

The display control unit 15d performs display control of the PAD. For example, the display control unit 15d uses the result of the determination by the determination unit 15c to filter and hide, from among the conditional branch nodes detected from the PAD, a branch node (a branch node under a conditional branch node) for a case in which the apparatus to be operated does not satisfy the condition set for the conditional branch node.

For example, the display control unit 15d filters and hides a branch node that does not match the OS name or the OS version of the apparatus to be operated, of the branch nodes under a conditional branch node on the PAD.

According to the operation support apparatus 10, in the PAD illustrating the operation procedure of apparatuses, it is possible to display a PAD that hides the operations that do not need to be performed on the apparatus to be operated and illustrates the operations to be performed on the apparatus to be operated.

### [Example of Processing Procedure]

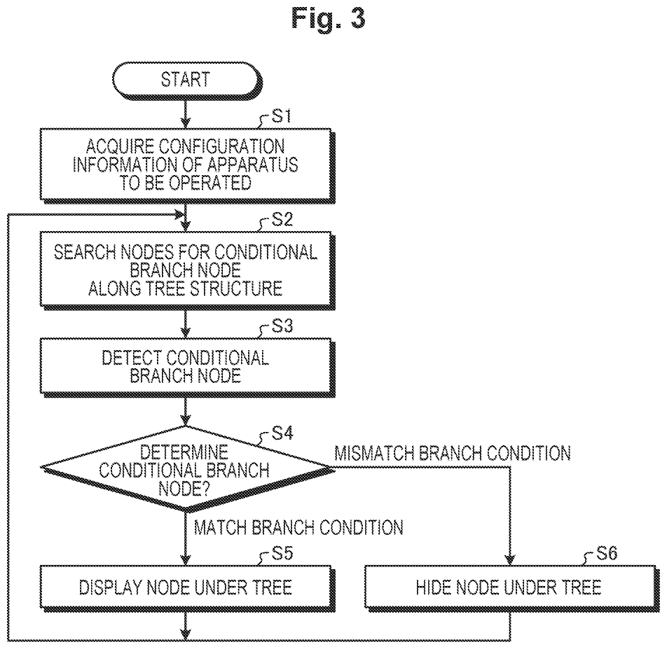

Next, an example of a processing procedure of the operation support apparatus 10 will be described with reference to FIG. 3. The processing illustrated in FIG. 3 is started, for example, at the timing when the operator inputs an instruction to the operation support apparatus 10, and is repeatedly executed.

First, the acquisition unit 15a of the operation support apparatus 10 acquires the configuration information from an apparatus to be operated (S1). Then, the acquisition unit 15a acquires, from the configuration information, a value (for example, OS name, OS version, and the like of the apparatus to be operated) related to determination on a conditional branch. Thereafter, the detection unit 15b uses the value acquired by the acquisition unit 15a to detect, from the PAD, a conditional branch node branching at the above value. For example, the detection unit 15b searches the nodes in the PAD for a conditional branch node along the tree structure (S2), and detects the conditional branch node that branches with the value related to the determination on the conditional branch (for example, OS name, OS version, and the like of the apparatus to be operated) (S3).

After S3, the determination unit 15c determines the conditional branch node by using the value related to the determination on the conditional branch (S4). For example, the determination unit 15c determines whether the OS name, the version of the OS, and the like of the apparatus to be operated match the branch condition set for the conditional branch node detected in S3. Here, if the determination unit 15c determines that the OS name, the version of the OS, and the like of the apparatus to be operated match the branch condition set for the conditional branch node (S4->match branch condition), the display control unit 15d displays the node that matches the branch condition in the tree (S5). The processing then returns to S2.

On the other hand, if the determination unit 15c determines that the OS name, the OS version, or the like of the apparatus to be operated does not match the branch condition set for the conditional branch node (S4->mismatch branch condition), the display control unit 15d hides the node in the tree (S6). The processing then returns to S2.

As the operation support apparatus 10 performs the above processing, in the PAD, it is possible to display a PAD that hides the operations that do not need to be performed on the apparatus to be operated and illustrates the operations to be performed on the apparatus to be operated.

### Second Embodiment

Note that the operation support apparatus 10 filters the branch nodes of the conditional branch nodes in the PAD based on the configuration information of the apparatus to be operated, but may filter the branch nodes based on a branch node selected by the operator. The operation support apparatus in this case will be described as an operation support apparatus 10a according to the second embodiment. The same configurations as those of the first embodiment are denoted by the same reference signs, and description thereof is omitted.

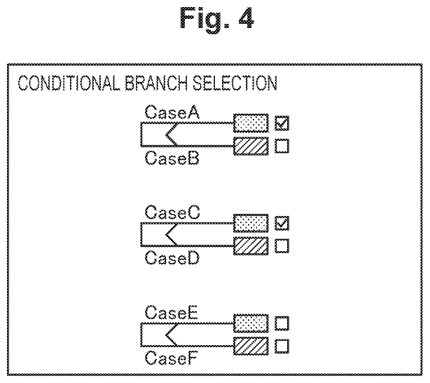

For example, when detecting conditional branch nodes from the PAD, the operation support apparatus 10a displays branch conditions of each detected conditional branch node on a screen as illustrated in FIG. 4. Then, the operation support apparatus 10a receives, from the operator, a selection input that selects which branch node satisfying which branch condition to display for each conditional branch node.

For example, as illustrated in FIG. 4, the operation support apparatus 10a receives, from the operator, a selection input for displaying a branch node that satisfies a branch condition of Case A for a conditional branch node branching into Case A and Case B. In addition, the operation support apparatus 10a receives, from the operator, a selection input for displaying a branch node that satisfies a branch condition of Case C for a conditional branch node branching into Case C and Case D.

In such a case, the display control unit 15d of the operation support apparatus 10a displays the branch node that satisfies the branch condition of Case A and hides the branch node that satisfies the branch condition of Case B for the conditional branch node branching into Case A and Case B based on the selection input described above. In addition, the display control unit 15d displays the branch node that satisfies the branch condition of Case C and hides the branch node that satisfies the branch condition of Case D for the conditional branch node branching into Case C and Case D based on the selection input described above.

In addition, when there are a plurality of conditional branch nodes in which the same condition is set in the PAD, the operation support apparatus 10a groups these nodes into a conditional branch node group and then performs the same processing as described above.

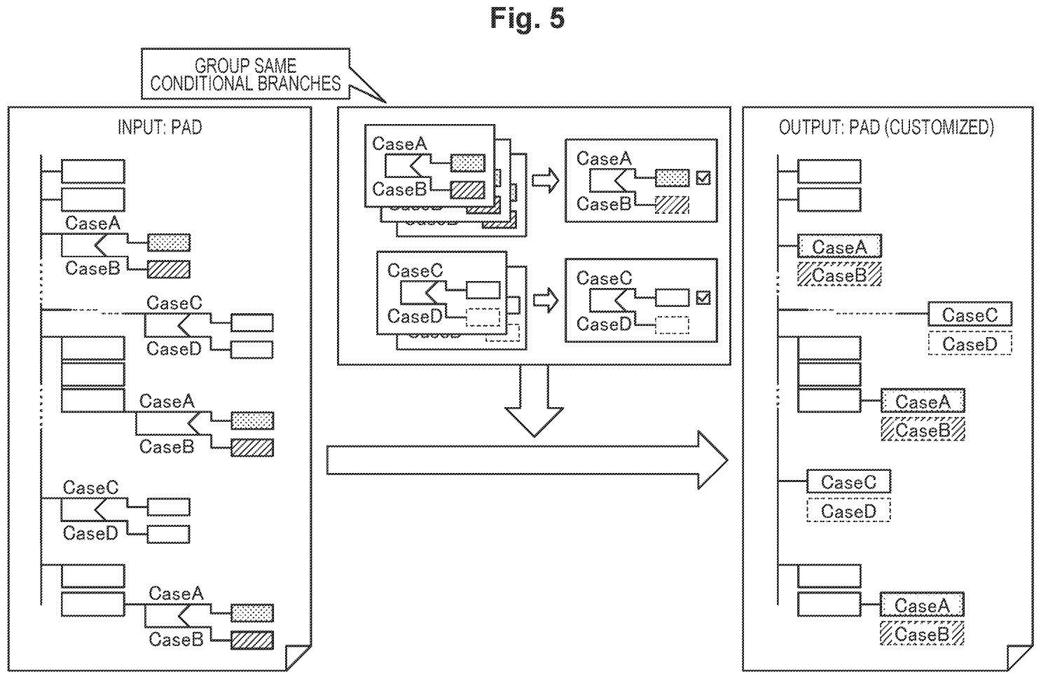

For example, the operation support apparatus 10a groups the conditional branch nodes for which Case A and Case B are set into a conditional branch node group and groups the conditional branch nodes for which Case C and Case D are set into another conditional branch node group among the conditional branch nodes in the PAD illustrated in FIG. 5. Then, the operation support apparatus 10a receives, for each conditional branch node group, the selection input that selects which operation node satisfying which branch condition set for the conditional branch node to display.

Then, the operation support apparatus 10a displays, based on the selection input (for example, Case A and Case C) from the operator, a branch node that satisfies the branch condition of Case A for each conditional branch node for which Case A and Case B are set on the PAD, and displays a branch node that satisfies the branch condition of Case C for each conditional branch node for which Case C and Case D are set.

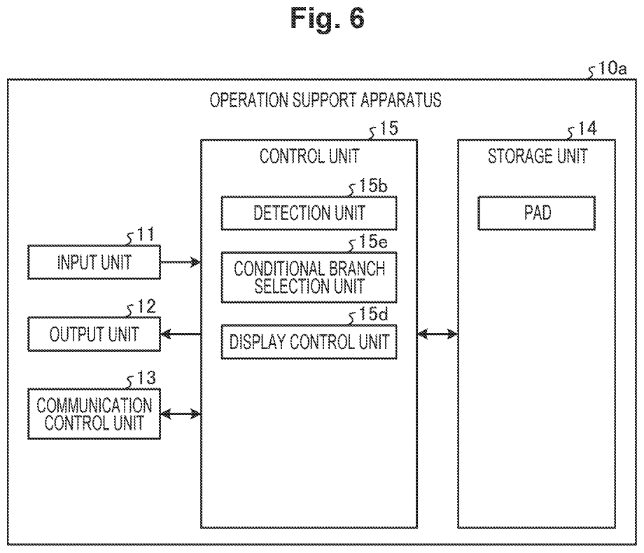

A configuration example of the operation support apparatus 10a is illustrated in FIG. 6. As illustrated in FIG. 6, the operation support apparatus 10a includes the detection unit 15b, a conditional branch selection unit 15e, and the display control unit 15d.

The detection unit 15b detects a conditional branch node from the PAD. In addition, if there are conditional branch nodes for which the same condition is set, the detection unit 15b groups these nodes into a conditional branch node group.

For the conditional branch node detected by the detection unit 15b, the conditional branch selection unit 15e receives, from the operator, the selection input that selects which branch node satisfying which branch condition set for the conditional branch node to display.

For the conditional branch node on the PAD detected by the detection unit 15b, the display control unit 15d displays the branch node that satisfies the branch condition selected by the conditional branch selection unit 15e, and hides the branch node that satisfies the branch condition not selected by the conditional branch selection unit 15e.

According to the operation support apparatus 10a, it is possible to display the branch node satisfying the branch condition desired by the operator on the PAD.

### Other Embodiments

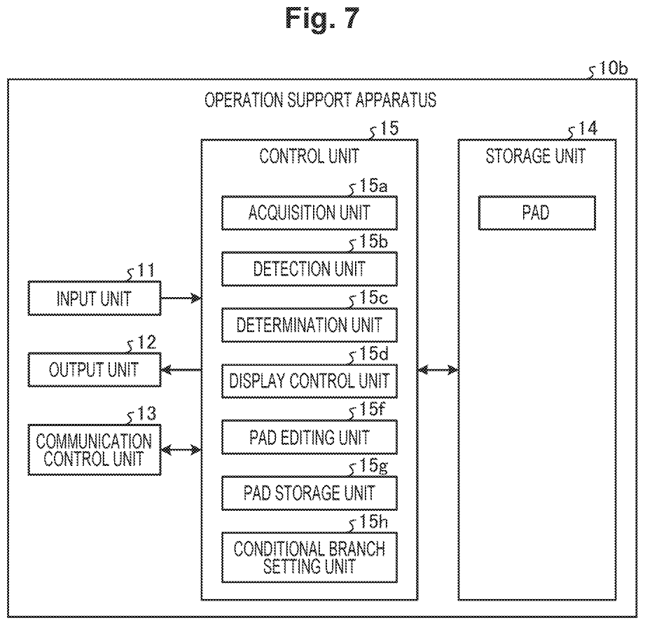

Note that the operation support apparatuses 10 and 10a may be equipped with functions of editing and storing the PAD, setting the branch nodes, and the like. For example, as in an operation support apparatus 10b illustrated in FIG. 7, the configuration of the operation support apparatus 10 may include a PAD editing unit 15f, a PAD storage unit 15g, and a conditional branch setting unit 15h.

The PAD editing unit 15f edits the PAD based on an instruction input from the input unit 11. The PAD storage unit 15g stores a PAD edited by the PAD editing unit 15f in the storage unit 14. The conditional branch setting unit 15h sets branch nodes to a conditional branch node on the PAD based on an instruction input from the input unit 11.

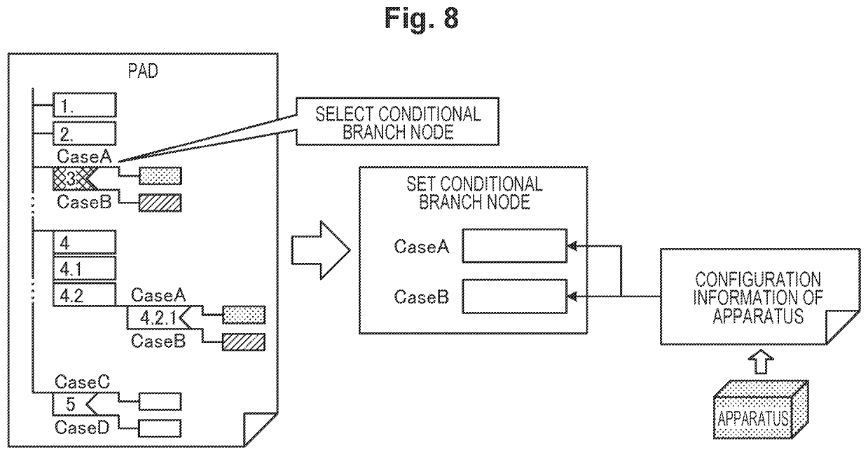

For example, as illustrated in FIG. 8, the conditional branch setting unit 15h receives, from the user, the OS name, version, and the like of an apparatus described in the configuration information of the apparatus as a branch condition corresponding to Case A and Case B for a conditional branch node on the PAD. Then, the conditional branch setting unit 15h sets the received branch condition for the conditional branch node on the PAD.

In this way, the user of the operation support apparatus 10b can edit and store the PAD, set the branch nodes, and the like.

In addition, the operation support apparatus 10 according to the first embodiment filters the branch nodes based on the configuration information of the apparatus to be operated, but may filter the branch nodes using information other than the configuration information. For example, the operation support apparatus 10 may acquire information indicating the current state of the apparatus to be operated and filter the branch nodes using the information.

### [Program]

It is also possible to create a program in which the processing executed by the operation support apparatuses 10, 10a, 10b according to the above embodiments is described in a language that can be executed by a computer. As an embodiment, the operation support apparatuses 10, 10a, 10b can be implemented by installing, as packaged software or online software, an operation support program for executing the operation support processing in a desired computer. For example, by causing an information processing apparatus to execute the operation support program, the information processing apparatus can function as the operation support apparatuses 10, 10a, 10b. The information processing apparatus described here includes a desktop or notebook personal computer. In addition, the category of the information processing apparatus includes a mobile communication terminal such as a smartphone, a mobile phone, or a personal handy phone system (PHS), a slate terminal such as a personal digital assistant (PDA), and the like. Further, the functions of the operation support apparatuses 10, 10a, 10b may be implemented in a cloud server.

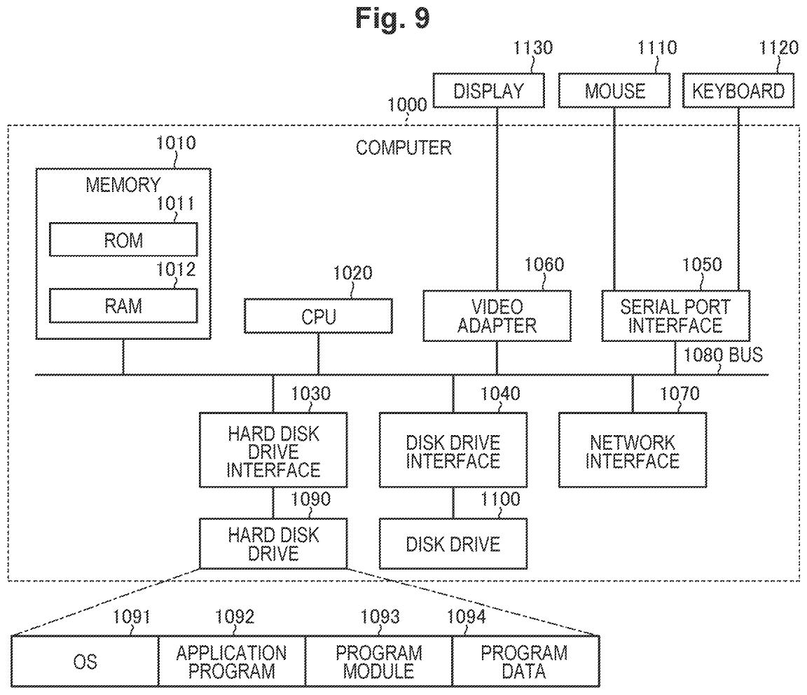

FIG. 9 is a diagram illustrating an example of a computer that executes the operation support program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. For example, the serial port interface 1050 is connected to a mouse 1110 and a keyboard 1120. The video adapter 1060 is connected to, for example, a display 1130.

Here, the hard disk drive 1090 stores, for example, an OS 1091, an application program 1092, a program module 1093, and program data 1094. Each piece of information described in the above embodiments is stored in, for example, the hard disk drive 1090 or the memory 1010.

In addition, the operation support program is stored, for example, in the hard disk drive 1090, as the program module 1093 in which commands to be executed by the computer 1000 are described. Specifically, the program module 1093 in which each piece of processing to be executed by the operation support apparatuses 10, 10a, 10b described in the above embodiments is described is stored in the hard disk drive 1090.

Further, data to be used for information processing performed by the operation support program is stored, for example, in the hard disk drive 1090, as the program data 1094. Then, the CPU 1020 reads the program module 1093 and the program data 1094 stored in the hard disk drive 1090 to the RAM 1012 as necessary, and executes each procedure described above.

Note that the program module 1093 and the program data 1094 related to the operation support program are not limited to being stored in the hard disk drive 1090, and may be stored, for example, in a removable storage medium and may be read by the CPU 1020 via the disk drive 1100 or the like. Alternatively, the program module 1093 and the program data 1094 related to the operation support program may be stored in another computer connected via a network such as a LAN or a wide area network (WAN), and may be read by the CPU 1020 via the network interface 1070.

Although the embodiments to which the invention made by the present inventors is applied have been described above, the present invention is not limited by the description and the drawings forming a part of the disclosure of the present invention according to the embodiments. In other words, other embodiments, examples, operational technologies, and the like made by those skilled in the art or the like on the basis of the embodiments are all included in the scope of the present invention.

### REFERENCE SIGNS LIST

10 Operation support apparatus
11 Input unit
12 Output unit
13 Communication control unit
14 Storage unit
15 Control unit
15a Acquisition unit
15b Detection unit
15c Determination unit
15d Display control unit
15e Conditional branch selection unit
15f PAD editing unit
15g PAD storage unit
15h Conditional branch setting unit

1. An operation support apparatus comprising:
a detection unit, including one or more processors, configured to detect, from operation flow information that represents an operation procedure for apparatuses by a tree structure in which an operation content is a node, a node of a conditional branch in the operation procedure; and
a display control unit, including one or more processors, configured to hide a branch node of branch nodes of the conditional branch node detected from the operation flow information, the branch node being for a case in which an apparatus to be operated does not satisfy a branch condition set for the conditional branch node.

2. The operation support apparatus according to claim 1, further comprising
an acquisition unit, including one or more processors, configured to acquire a value related to determination on the conditional branch from configuration information of the apparatus to be operated, wherein
the detection unit, including one or more processors, configured to detect conditional branch nodes from the operation flow information by using the acquired value,
the operation support apparatus further comprising
a determination unit, including one or more processors, configured to determine, for each of the detected conditional branch nodes, whether the apparatus to be operated satisfies a branch condition set for the conditional branch node by using the acquired value, wherein
the display control unit, including one or more processors, configured to hide, by using a result of the determination, a branch node of the branch nodes, the branch node being for a case in which the apparatus to be operated does not satisfy the branch condition set for the conditional branch node.

3. The operation support apparatus according to claim 1, wherein
the operation flow information is information describing the operation procedure for apparatuses by a problem analysis diagram (PAD).

4. An operation support method executed by an operation support apparatus, the operation support method comprising:
detecting, from operation flow information that represents an operation procedure for apparatuses by a tree structure in which an operation content is a node, a node of a conditional branch in the operation procedure; and
hiding a branch node of branch nodes of the conditional branch node detected from the operation flow information, the branch node being for a case in which an apparatus to be operated does not satisfy a branch condition set for the conditional branch node.

5. A non-transitory computer readable medium storing one or more instructions causing a computer to execute:
detecting, from operation flow information that represents an operation procedure for apparatuses by a tree structure in which an operation content is a node, a node of a conditional branch in the operation procedure; and
hiding a branch node of branch nodes of the conditional branch node detected from the operation flow information, the branch node being for a case in which an apparatus to be operated does not satisfy a branch condition set for the conditional branch node.
